(19) United States
(12) Patent Application Publication
(10) Pub. No.: US 2023/0276496 A1
(43) Pub. Date: Aug. 31, 2023

(54) METHODS FOR COMMUNICATING A BURST OF SYNCHRONIZATION SIGNAL BLOCKS

(71) Applicant: Sony Group Corporation, Tokyo (JP)

(72) Inventors: Kåre AGARDH, Rydebäck (SE); Erik BENGTSSON, Eslöv (SE); Fredrik RUSEK, Eslöv (SE); Kun ZHAO, Malmö (SE); José FLORDELIS, Lund (SE)

(21) Appl. No.: 18/012,558

(22) PCT Filed: Jun. 28, 2021
(86) PCT No.: PCT/EP2021/067693

§ 371 Date: Dec. 22, 2022

(30) Foreign Application Priority Data
Jul. 9, 2020 (SE) 2050880-0

(51) Int. Cl. H04W 74/08

(52) U.S. Cl. CPC H04W 74/0816

(57) ABSTRACT

Disclosed is a method, performed at a network node, for transmitting a burst of Synchronization Signal Blocks according to this disclosure. The burst of SSBs comprises a first SSB and a second SSB. The network node is configured to communicate with a wireless device using a plurality of beams in a frequency band requiring clear channel assessment, CCA. The method comprises monitoring, using a first beam, a channel between the network node and the wireless device as part of a first CCA. The method comprises determining a scheme for transmission of SSBs, amongst a plurality of schemes. The method comprises upon determining, based on the first CCA, that the channel is clear for the first beam, transmitting, using the first beam, the first SSB indicative of the determined scheme.

The present disclosure pertains to the field of wireless communications. The present disclosure relates to methods for communicating a burst of synchronization signal blocks, related network nodes and related wireless devices.

### BACKGROUND

In licensed bands, a network node (such as a gNB) periodically transmits a burst of Synchronization Signal Blocks, SSBs, with a typical period of 20 ms. Each SSB burst has a duration of up to 5 ms. Transmissions of SSBs are conceptually illustrated in FIG. 2. In 5G New Radio, NR, a burst of SSBs comprises up to 64 SSBs, and each SSB is transmitted over 4 OFDM symbols. Typically, each SSB is associated with a different beam. The different beams (beam 1-beam N in FIG. 2) are transmitted in different directions.

In the Physical Random Access Channel, PRACH, resources, a wireless device (such as a User Equipment, UE) is supposed to respond when the wireless device detects a beam. There is at least one PRACH resource associated to every beam. Each SSB beam transmission occupies 4 OFDM symbols, which corresponds to, typically, 20 μs-100 μs in FR2. This depends on numerology.

However, the transmission structure illustrated in FIG. 2 cannot be used in a frequency band requiring clear channel assessment, (such as unlicensed bands) due to regulatory conditions associated with such frequency bands. The regulatory conditions turn out to be prohibitive for the SSB structure shown in FIG. 2.

### SUMMARY

Accordingly, there is a need for network nodes, wireless devices and methods for communication of a burst of SSBs, which mitigate, alleviate or address the shortcomings existing and provide schemes which efficiently support beam transmission of SSBs for frequency bands requiring clear channel assessment.

Disclosed is a method, performed at a network node, for transmitting a burst of Synchronization Signal Blocks according to this disclosure. The burst of SSBs comprises a first SSB and a second SSB. The network node is configured to communicate with a wireless device using a plurality of beams in a frequency band requiring clear channel assessment, CCA. The method comprises monitoring, using a first beam, a channel between the network node and the wireless device as part of a first CCA. The method comprises determining a scheme for transmission of SSBs, amongst a plurality of schemes. The method comprises upon determining, based on the first CCA, that the channel is clear for the first beam, transmitting, using the first beam, the first SSB indicative of the determined scheme. The method comprises monitoring, using a second beam and according to the determined scheme, the channel as part of a second CCA. The method comprises upon determining, based on the second CCA, that the channel is clear for the second beam, transmitting, using the second beam, the second SSB according to the determined scheme.

Further, a network node is provided, the network node comprising circuitry configured to cause the network node to perform any of the methods disclosed herein.

It is an advantage of the present disclosure that the disclosed network node and related method provide a scheme for transmissions of SSBs which is compatible with the restrictions of frequency bands requiring clear channel assessment, such as the unlicensed bands. The disclosed network node and related method allow beam transmissions of SSBs with an improved performance in enabling a wireless device to access the random access channel. Advantageously, the disclosed network node and related method provide a scheme that may be interoperable with the scheme(s) used in the licensed band. In some examples, the resources are more effectively used and more beam transmissions of SSBs can be performed in the same time duration. The disclosed network may be beneficial for various configurations, such as when a single antenna panel is used at the network node or in full duplex.

Disclosed is a method, performed at a wireless device, for receiving a burst of Synchronization Signal Blocks, SSB. The burst of SSBs comprises a first SSB and a second SSB. The wireless device, WD, is configured to communicate with a network node using a plurality of beams in a frequency band requiring clear channel assessment. The method comprises receiving, using a first WD beam, the first SSB from the network node.

The method comprises determining, based on the first SSB, an expected reception time of the second SSB. The method comprises monitoring, using a second WD beam and the expected reception time, for the second SSB from the network node.

Further, a wireless device is provided, the wireless device comprising circuitry configured to cause the wireless device to perform any of the methods disclosed herein.

It is an advantage of the present disclosure that the disclosed wireless device and related method can provide an access to the random access channel in the unlicensed band with a scheme that may become interoperable with the scheme(s) used in the licensed band. This in turn may lead to power savings at the wireless device.

Disclosed is a method, performed at a network node, for transmitting a burst of Synchronization Signal Blocks, SSBs, according to this disclosure. The burst of SSBs comprises a first set of SSBs associated with a first beam and a second set of SSBs associated with a second beam. The network node is configured to communicate with a wireless device, using a plurality of beams comprising the first beam and the second beam, in a frequency band requiring clear channel assessment, CCA. The method comprises monitoring using a first beam, a channel between the network node and the wireless device as part of a first CCA. The method comprises upon determining, based on the first CCA that the channel is clear for the first beam, transmitting, using the first beam, at least one SSB of the first set of SSBs according to a first scheme, wherein the first scheme is configured to allow for a first Random Access Channel, RACH, reception after transmission of at least one SSB of the first set of SSBs and prior to transmitting at least one SSB of the second set of SSBs using a second beam. The method comprises monitoring, using the first beam, for the first RACH reception. The method comprises monitoring, using the second beam, the channel as part of a second CCA. The method comprises upon determining, based on the second CCA, that the channel is clear for the second beam, transmitting, using the second beam, at least one SSB of the second set of SSBs according to a second scheme.

Further, a network node is provided, the network node comprising circuitry configured to cause the network node to perform any of the methods disclosed herein.

It is an advantage of the present disclosure that the disclosed network node and related method provide a more efficient and more robust access to the random access channel e.g. when the traffic load increases in an unlicensed band. For example, also the network node has performed CCA in a spatial direction, then the wireless device can immediately respond in the corresponding reverse direction (within the Channel Occupancy Time, COT) without having to perform the CCA. This greatly shortens the lead time for a successful random access procedure, especially in scenarios with high traffic load. Advantageously, the disclosed network node and related method provide a scheme that is compatible with frequency bands requiring CCA.

Disclosed is a method, performed at wireless device, for receiving a burst of Synchronization Signal Blocks, SSBs according to this disclosure. The burst of SSBs comprises a first set of SSBs associated with a first beam, and a second set of SSBs associated with a second beam. The wireless device, WD, is configured to communicate with a network node using a plurality of beams in a frequency band requiring clear channel assessment. The method comprises receiving, from the network node, using a first WD beam, control signalling indicative of a first scheme, wherein the first scheme indicates a first Random Access Channel, RACH, resource after reception of the SSB of the first set and prior to monitoring for at least one SSB of the second set of SSBs using a second beam. The method comprises transmitting, using the first WD beam, to the network node, a signal using the first RACH resource according to the first scheme. The method comprises monitoring, using a plurality of WD beams and a second scheme, for a second SSB from the network node, after the RACH transmission.

Further, a wireless device is provided, the wireless device comprising circuitry configured to cause the wireless device to perform any of the methods disclosed herein.

It is an advantage of the present disclosure that the disclosed wireless device is not required to perform CCA to respond to the SSB over RACH and can readily respond within the COT in the corresponding reverse direction where the network node has performed the CCA. The disclosed wireless device and related method provide SSB transmission schemes which are compatible with the restrictive regulations of the frequency bands requiring CCA, such as the unlicensed band. The wireless device disclosed herein may benefit from an increased chance to access the random access channel, also a reduced latency in response to SSB transmission (possibly even compared with the licensed bands).

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating communication of Synchronization Signal Blocks, SSBs in the licensed band,

FIGS. 3A-3D are diagrams illustrating examples of communication of Synchronization Signal Blocks, SSBs according to this disclosure,

FIG. 4 is a flow-chart illustrating an example method, performed at a network node, for transmitting a burst of Synchronization Signal Blocks, SSBs, according to this disclosure,

FIG. 5 is a flow-chart illustrating an example method, performed at a wireless device, for receiving a burst of Synchronization Signal Blocks, SSBs according to this disclosure,

FIG. 6 is a flow-chart illustrating an example method, performed at a network node, for transmitting a burst of Synchronization Signal Blocks, SSBs, according to this disclosure,

FIG. 7 is a flow-chart illustrating an example method, performed at a wireless device, for receiving a burst of Synchronization Signal Blocks, SSBs according to this disclosure,

FIG. 8 is a block diagram illustrating an example wireless device according to this disclosure,

FIG. 9 is a block diagram illustrating an example network node according to this disclosure, and

FIG. 10 is a block diagram illustrating an example wireless device according to this disclosure, and

FIG. 11 is a block diagram illustrating an example network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

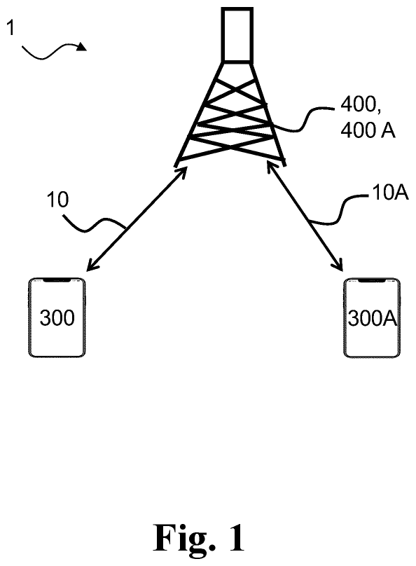

FIG. 1 is a diagram illustrating an example wireless communication system 1 comprising an example network node 400, 400A and an example wireless device 300, 300A according to this disclosure.

As discussed in detail herein, the present disclosure relates to a wireless communication system 1 comprising a cellular system, for example, a 3rd Generation Partnership Project, 3GPP, wireless communication system. The wireless communication system 1 comprises a wireless device 300, 300A and/or a network node 400, 400A.

A network node disclosed herein refers to a radio access network, RAN, node operating in the radio access network, such as a base station, an evolved Node B, eNB, and/or gNB. In one or more examples, a RAN node is a functional unit which may be distributed in several physical units.

The wireless communication system 1 described herein may comprise one or more wireless devices 300, 300A, and/or one or more network nodes 400, 400A, such as one or more of: a base station, an eNB, a gNB and/or an access point.

A wireless device may refer to a mobile device and/or a user equipment, UE.

The wireless device 300, 300A may be configured to communicate with the network node 400, 400A via a wireless link (or radio access link) 10, 10A.

As disclosed herein, a scheme may be seen as a mechanism and/or a procedure for transmission of SSBs. For example, a scheme may be a procedure defining one or more of: a time spacing between the first SSB and the second SSB, a sequence of beam transmissions of SSBs, and subcarrier spacing and/or symbol duration.

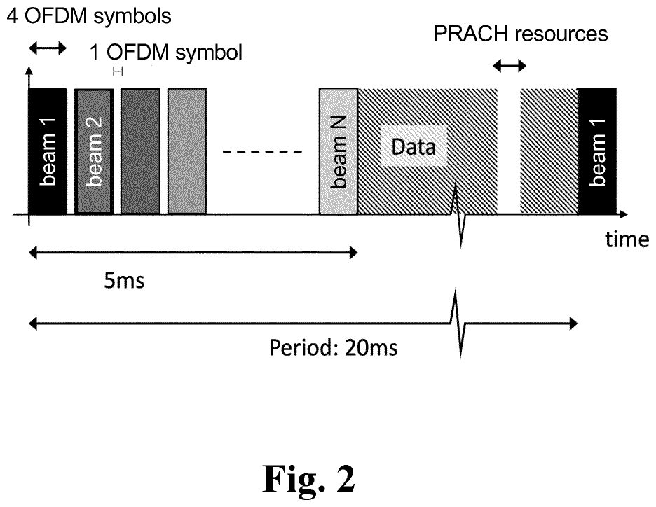

FIG. 2 is a diagram illustrating an example communication of Synchronization Signal Blocks, SSBs in the licensed band.

Each burst SSB has a duration of up to 5 ms. Transmissions of the burst of SSBs are illustrated in FIG. 2. In 5G New Radio, NR, a burst of SSBs comprises up to 64 SSBs, and each SSB is transmitted over 4 OFDM symbols. Typically, each SSB is associated with a different beam. The different beams (beam 1-beam N in FIG. 2) are transmitted in different directions.

In the Physical Random Access Channel, PRACH, resources, a wireless device (such as User Equipment, UE) is supposed to respond to at least one SSB when the wireless device detects one or more beams (for example, when the signal level is sufficiently strong to be detected). In other words, the wireless device may detect multiple SSB beams but responds to one of the beams (such as the strongest one).

For example, before being allowed to transmit on the RACH, the wireless device needs to gain synchronization (such as time, frequency, and/or beam) with the network node. For that, the wireless device needs to detect a suitable SSB. There is at least one PRACH resource associated with every beam. Each SSB beam transmission occupies 4 OFDM symbols, which corresponds to, typically, 20 μs-100 μs in FR2. This depends on numerology.

A burst of SSBs may be transmitted with a periodicity of 20 ms as illustrated in FIG. 2

The SSB transmission illustrated in FIG. 2 is for transmissions in licensed frequency bands, such as NR licensed band. However, for unlicensed bands, an NR network node or gNB cannot send an SSB in the same way as in the licensed band. Therefore, the SSB transmission scheme is to be redesigned to allow for various implementations. This disclosure provides, in one or more examples, SSB transmission schemes which are unlicensed-compatible. For example, the disclosed SSB transmission schemes may be interoperable with the design of licensed SSB transmission schemes. For example, the disclosed SSB transmission schemes can be used for licensed bands when the wireless either (1) uses an SSB-detection-algorithm not based on the known separation between SSB in licensed bands, or (2) is made aware of the actual separation used in the SSB transmission scheme.

Restrictions due to regulations in frequency bands requiring CCA, such as in the unlicensed band, have an impact on the SSB transmissions. For example, prior to any transmission in a certain spatial direction, a transmitting device (such as a network node or a wireless device) must monitor (via Listen-Before-Talk LBT and/or Clear Channel Assessment) the channel for a time period, such as at least T_{CCA}. The time period is for example between 5 μs and 32 μs depending on spectrum. When the incoming energy during T_{CCA} in the monitored spatial direction is less than a preconfigured threshold (associated with an antenna configuration), the transmitting device may start transmission in said spatial direction. When the channel has been monitored and no other transmissions above the energy threshold are detected on the channel, the transmitting device can get ownership of the channel and start transmitting, possibly instantly. When the transmitting device has started to transmit in the certain spatial direction, bi-directional communications must be continuous in said spatial direction and/or the reverse direction (the transmitting device may not be inactive or silent for more than a very short time (<T_{CCA})) in order to not lose its ownership of the channel, up to the max Channel Occupancy Time, COT. According to the regulations in an unlicensed band, when the LBT or CCA fails (for example, when another device transmits on the channel during T_{CCA}), the transmitting device may attempt to gain access to the channel after a random waiting time (so called, a contention window). This relates to a specific spatial configuration (e.g. beam).

It is to be noted that the regulatory conditions prohibit the SSB transmission scheme of FIG. 2 due to various technical constraints. Prior to transmission, the network node must perform a CCA or LBT. However, it is not sufficient to perform CCA or LBT for all beams prior to “beam 1” in FIG. 2 because the network node transmits using its beams in different directions, which may lead to a time gap larger than T_{CCA} from the CCA of each beam of the N beams to the transmission using the last beam. For example, it may be problematic already for transmitting beam 2 or 3. Furthermore, the network node may not be capable of operating in full duplex mode, wherefore a CCA in beam direction k cannot be conducted simultaneously because beam k-1 is used for transmission. It may be envisaged that in some situations, performing CCA prior to beam 1 in FIG. 2 permits for the transmission of beam 1, but no further beams.

It is to be noted that due to the directivity of transmissions at millimeter wave frequencies, the impact of the restrictions do not allow the legacy licensed method illustrated in FIG. 2 to apply, for example, in millimeter wave communication systems.

In licensed bands, the wireless devices are supposed to respond to SSB beams during the PRACH resources—which are located further away in time (>>T_{CCA}) from the SSBs. This becomes challenging in unlicensed bands. Before the wireless device can respond in PRACH, the wireless device has to perform a CCA of its own. In a scenario with high traffic on the shared medium, wherein p denotes the probability that a wireless device and/or a network node is allowed to transmit after CCA, the probability for successful transmission of the SSB beam and successful transmission of the response over PRACH is p². For low values of p due to traffic conditions, the likelihood that the wireless device can successfully access the channel becomes especially low. It may be envisaged to increase the PRACH resource count associated with each beam, which can cause an increased overhead and is therefore not desirable.

It is to be noted that the NR-U release targets low frequency bands where transmissions are omnidirectional, and hence do not need to deal with the challenges identified.

IEEE 802.11ad and 802.11ay defines Wi-Fi (WiGig) communication in the 60 GHz spectrum operating under the same regulation requirements related to T_{CCA}, and COT but have a very different signaling behavior.

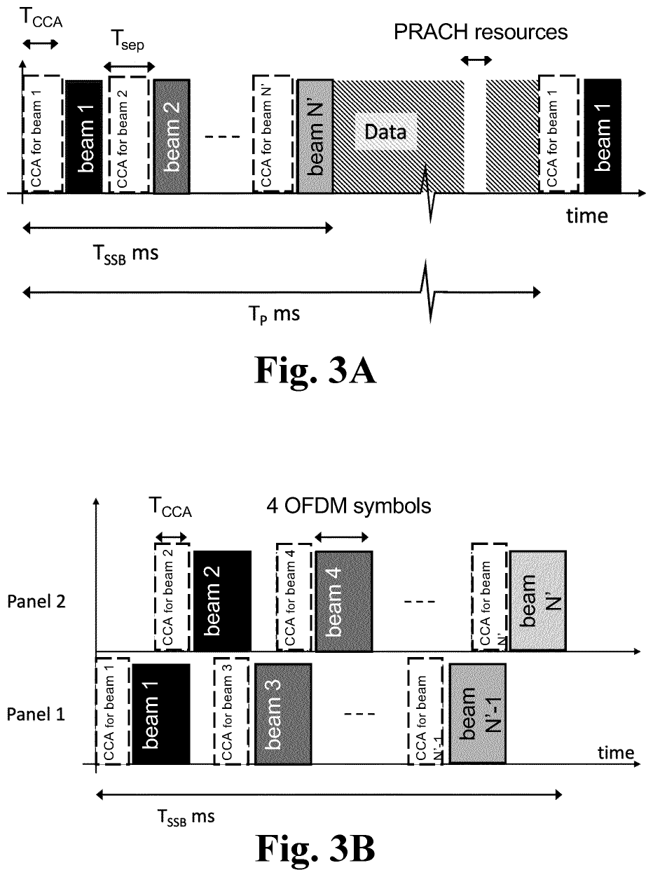

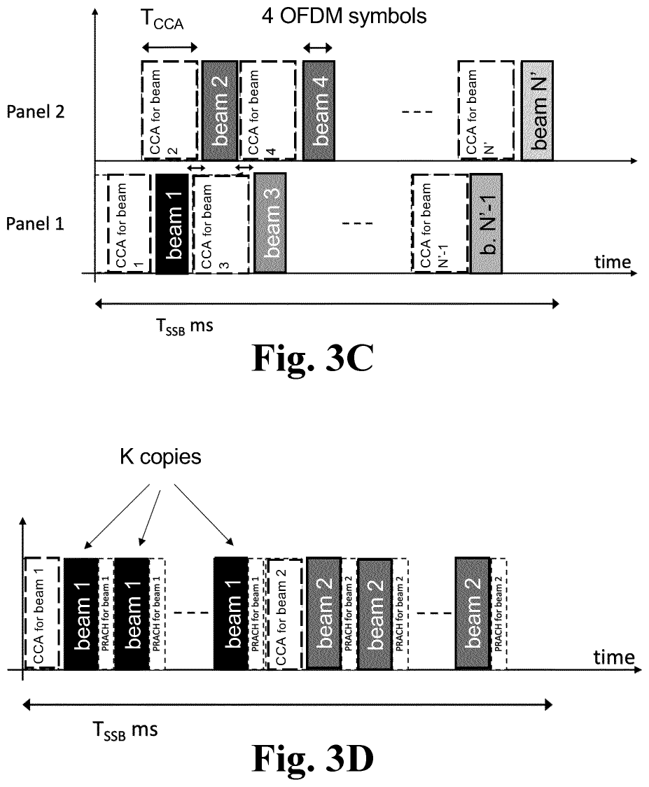

FIGS. 3A-3D are diagrams illustrating examples of communication of Synchronization Signal Blocks, SSBs according to this disclosure. FIGS. 3A-3D show various example SSB transmission schemes for a frequency band requiring CCA, such as the unlicensed band.

An SS block can comprise one symbol for Primary SS, one symbol for Secondary SS and 2 symbols Physical Broadcast Channel, PBCH. A burst of SSBs can carry one or multiple SSBs.

T_{SSB} denotes the SSB burst transmission time and Tp denotes the periodicity of the SSB burst transmission. Values of T_{SSB} depend on numerology and the number of beams used. In some examples, T_{SSB} takes the same value as for licensed bands, then N′<N where N′ denotes the number of beams in FIGS. 3A-3C while N denotes the number of beams in the licensed band of FIG. 2.

The SSBs disclosed herein are indicative of a scheme for transmissions of SSBs which is determined by the network node. For example, the UE can start listening at any time and needs to be able to figure out when the next SSB is expected. For this reason, such information enabling the UE to figure out when the next SSB is expected may be encoded in the SSB transmissions themselves.

In FIG. 3A, prior to each beam transmission of an SSB, there is a CCA in the same direction as the intended beam direction. When it is determined that no energy exceeding the threshold is detected in said direction, the network node may transmit using the beam.

In order for the wireless device to operate, the wireless device is informed of the scheme for SSB transmission, for example that the SSB beams are not transmitted 1 OFDM symbol apart (as in licensed band), and that some of SSBs may not even be transmitted due to detected activity during the associated CCA period.

Tsep denotes the time period separating the end of the transmission over a first beam and the beginning of consecutive transmission over a second beam.

The burst of SSBs comprises a first SSB, a second SSB, and optionally further SSBs up to a total of N′ SSBs. The network node, NN, is configured to communicate with a wireless device using a plurality of beams in a frequency band requiring clear channel assessment, CCA.

The plurality of beams comprises the Tx beams of the NN, such as one or more of beams 1 to beam N′. The SSB burst transmissions may be directed at one or more Rx WD beams.

The network node monitors, using a first beam shown as “beam 1”, a channel between the network node and the wireless device as part of a first CCA illustrated as “CCA for beam 1” in FIG. 3A. The network node determines, based on the first CCA, whether the channel is clear for the first beam “beam 1”.

The network node determines a scheme for transmission of SSBs, amongst a plurality of schemes.

The network node upon determining, based on the first CCA, that the channel is clear for the first beam, transmits, using the first beam shown as “beam 1”, the first SSB indicative of the determined scheme.

The network node monitors, using a second beam shown as “beam 2” and according to the determined scheme, the channel as part of a second CCA illustrated as “CCA for beam 2”.

The network node, upon determining, based on the second CCA, that the channel is clear for the second beam, transmits, using the second beam shown as “beam 2”, a second SSB according to the determined scheme.

FIG. 3B shows a scheme which may be advantageous for a network node equipped with multiple quasi collocated antenna panels. The scheme allows for one antenna panel to perform CCA while another antenna panel is transmitting a beam (practically full duplex, but in different spatial configurations). FIG. 3B shows two antenna panels: Panel 1 and Panel 2. For example, Panel 1 performs CCA for beam 1 and then transmits an SSB using beam 1. For example, while Panel 1 transmits the SSB using beam 1, Panel 2 can perform CCA for beam 2. It is noted that Tsep present in FIG. 3A is avoided in FIG. 3B with the net effect that more beams can be used during the same time duration T_{SSB} (for example, the same as for the licensed SSB as experienced by the wireless device). The disclosed method extends to an arbitrary number of antenna panels. Alternatively, T_{SSB} may be reduced. In some examples, the disclosed method supports dedicated receive-only antenna panels in combination with transmit-only antenna panels.

Depending on numerology, with an increased sub-carrier spacing, the OFDM symbol time reduces. A typical SSB block within the SSB burst (SSB beam transmission) uses 4 OFDM symbols, and the total time duration for one SSB beam transmission can be less or larger than T_{CCA}. For example, it may be envisaged that 4 OFDM symbol time exceeds T_{CCA}, which leads to one or more example schemes illustrated in FIG. 3B.

In FIG. 3B, adjacent beams are transmitted from different antenna panels, and it is assumed that isolation between antenna panels is sufficiently good so that one antenna panel can perform CCA while another is transmitting.

In FIG. 3B, the separation between two beams transmissions may be one OFDM symbol. However, some beams may not be transmitted (for example because the CCA failed in those beam directions). In other words, the wireless device may not be able to carry out 100% repeatability in the downlink beam sweeps. Further, one antenna panel can act as a transmit antenna panel while the other antenna panel is a receive panel.

FIG. 3C shows an example of an SSB transmission scheme exploiting two antenna panels and where four OFDM symbol times are less than T_{CCA}. Besides, the separation between two beam SSB transmissions may be greater than one OFDM symbol, the scheme is similar to the one of FIG. 3C. Also, for this case, dedicated receive and transmit panel(s) can be used. For this case, the receive panel needs to support multiple simultaneous receive beams as they may overlap in time. Alternatively, multiple receive panels can be used.

In some examples, schemes illustrated in FIG. 3A and FIGS. 3B-C advantageously provide the ability to perform SSB transmission in unlicensed bands. Schemes illustrated in FIG. 3A and FIGS. 3B-C structure (FIG. 3A may be viewed as a baseline) provide that more beams can be included into the same time duration. This may lead to a more effective use of the resources.

In one or more examples, Tsep may be provided to the wireless device where Tsep is the time gap between two adjacent beam transmissions. In some examples, Tsep may not be shared with the wireless device since the SSB signal itself may contain a synchronization signal. For example, when the wireless device is aware that a determined scheme as illustrated in FIGS. 3A, and 3B-C is used, then the wireless device can search for the next SSB beam without any prior assumption on when in time the SSB transmission would occur. For example, the values that Tsep can take may be limited in the standard to a limited set of values, e.g., two or three values. It may be beneficial in some examples to share Tsep with the wireless device since this saves synchronization complexity at the wireless device. In some examples, Tsep can be shared with the wireless device in each SSB beam transmission, and more efficiently during the initial connection setup. It may be appreciated that a one-time-Tsep-sharing may be envisaged since the network nodes don't change SSB beam transmission scheme. There may be no need to specify whether the scheme of FIG. 3A or 3B-C is used, since the only thing separating these schemes is Tsep in some examples. For example, in FIGS. 3B-3C, the example scheme(s) can use more SSB signals than what is possible in the schemes illustrated in FIG. 3A.

The SSB may be indicative of the scheme for SSB transmission. The SSB may be indicative of how many beams, repetition rate and current SSB position (beam identifier). For example, the wireless device knows the search space based on the first SSB it detects.

FIG. 3D shows example schemes for SSB transmission where the wireless device can respond immediately after reception of an SSB beam (e.g. based on the COT). The example schemes illustrated in FIG. 3D allow to address the severity amplified by an increase in traffic load and does not suffer from delays before the network and the wireless device can establish connection.

In FIG. 3D, the network node transmits bursts (a set of K copies) of the same SSB beam transmission, with PRACH resources interlaced so that the total duration of the K copies is within the COT. A PRACH resource may be provided at the end of K copies of SSB1 over Beam 1. In some examples, a PRACH resource may be provided at the beginning and at the end of K copies of SBB1 over Beam 1.

The network node monitors using a first beam “beam 1”, a channel between the network node and the wireless device as part of a first CCA.

The network node upon determining, based on the first CCA that the channel is clear for the first beam, transmit, using the first beam “beam 1”, at least one SSB of the first set of SSBs according to a first scheme. The first scheme is configured to allow for a first Random Access Channel, RACH, reception after transmission of at least one SSB of the first set of SSBs and prior to transmitting at least one SSB of the second set of SSBs using a second beam.

The network node monitors, using the first beam “beam 1”, for the first RACH reception illustrated as PRACH for beam 1 in FIG. 3D.

The network node monitors, using the second beam “beam 2”, the channel as part of a second CCA. The network node upon determining, based on the second CCA, that the channel is clear for the second beam, transmits, using the second beam “beam 2”, at least one SSB of the second set of SSBs according to a second scheme.

It may be appreciated that the wireless device does not need to perform any CCA operation, since regulations states that when the network node has performed CCA in a spatial direction, then the wireless device can immediately respond in the corresponding reverse direction (within the COT). The example scheme of FIG. 3D complies with the regulations since it is continuously transmitting in the corresponding reverse direction, except for during the PRACH resources that have to be less than T_{CCA}. In some examples, a single beam per burst (such as K=1) may be sufficient. For example, the wireless device may need to switch from receive to transmit in a very short time and the wireless device may perform a receive beam sweep (or part of). As it may take some time for the wireless device to switch from receive to transmit, the network node transmits K beams to address this. It may be assumed that there is a switch gap, where no data is transmitted, between DL and UL. Multiple PRACH resources may be used to minimize collisions (two UEs hearing the same beam, but at different time slots within the same burst, will likely respond in different PRACH resources).

In FIG. 3D, the example scheme(s) provide an improvement, for example in that a connection between the network node and the wireless device becomes possible to establish with a (much) higher probability than for FIG. 3A-3C (particularly for example in high traffic scenarios). It may be appreciated that the wireless device does not need to perform CCA for the scheme(s) illustrated in FIG. 3D.

For FIG. 3D, a wireless device is to be informed of the scheme used, as the Rx beam management of the wireless device (e.g. sweep) is affected, so the network node shares this information, e.g. via the SSB or via control signalling. This way, the wireless device that wakes up and receives an SSB knows when to respond and what algorithm to use for the receive beam sweep.

It may be envisaged that for example, a wireless device that is already connected with the network over licensed band, can further improve the capability by including the unlicensed spectrum with carrier aggregation (CA), dual connectivity (DC), and the signaling of SSB scheme on unlicensed band can be sent over the licensed band.

In some examples, for legacy UEs, not equipped with capability to operate according to the example schemes of FIG. 3D, conventional PRACH resources may be added at conventional locations (announced in the PBCH, within each SSB).

It may be envisaged that the various example schemes may be advantageous for an unlicensed NR system, and the network node may switch between the schemes when traffic load increases. Information about this switch may be located in the SSB or as a dedicated signal.

It may be envisaged that for a given first beam, the CCA fails, and the network node proceeds with CCA according to any of the FIGS. 3A-3D for one or more other beams. It may be envisaged that after a random time, the given first beam may be used for CCA again, within the structure laid out in FIGS. 3A-3D.

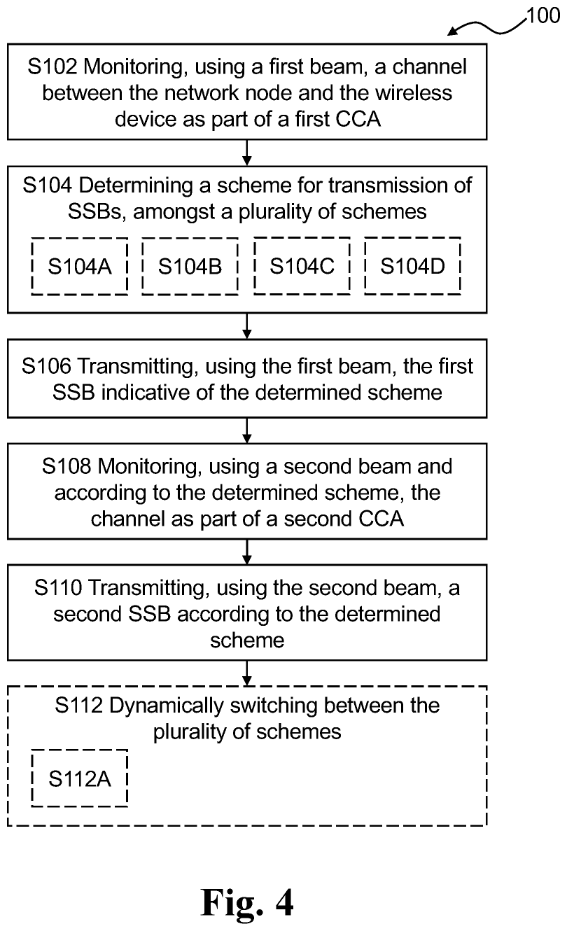

FIG. 4 is a flow-chart illustrating an example method 100, performed at a network node, for transmitting a burst of Synchronization Signal Blocks according to this disclosure. The burst of SSBs comprises a first SSB and a second SSB. The network node is configured to communicate with a wireless device, WD, using a plurality of beams in a frequency band requiring clear channel assessment, CCA. The frequency band is for example a band where Listen-Before-Talk and/or CCA is applied, such as the unlicensed frequency band.

A beam may be seen as a direction, such as a spatial direction.

The plurality of beams comprises for example one or more beams of the network node, NN, (referred to as NN beams), and/or one or more beams of the wireless device (referred to as WD beams). A beam can be a receive, Rx, beam or a transmit, Tx, beam. For example, in uplink, the network node can communicate with the wireless device (such as receive) via a Tx beam of the wireless device directed at (e.g. received by) a Rx beam of the network node. For example, in downlink, the network node can communicate (such as transmit) with the wireless device using a Tx beam of the network node directed at (e.g. received by) a Rx beam of the wireless device. In some examples, a WD Rx and a WD Tx beam may have the same spatial profile, for example may have beam correspondence.

The method 100 may be seen as carried out during the time period of the SSB burst transmission, e.g. within a time period of a periodicity of the SSB burst transmissions (for example Tₚ of FIG. 3A).

The method 100 comprises monitoring S102, using a first beam, a channel between the network node and the wireless device as part of a first CCA. The first beam may be seen as a Rx beam of the network node. In other words, the network node performs, using the first beam (which is an NN Rx beam), the first CCA of the channel between the network node and the wireless device before attempting to access the channel. The CCA may be performed by determining a received energy level over a channel bandwidth frequency band. The clear channel assessment may be carried out for a predetermined time period, (illustrated as T_{CCA} in FIG. 3A-C).

The method 100 comprises determining S104 a scheme for transmission of SSBs, amongst a plurality of schemes. The network node may be configured to carry out a plurality of schemes for transmission of SSBs. A scheme may be seen as a configuration of the transmission of the SSBs forming the burst, such as resource allocations, time allocation, beam identifier. The scheme may be seen as a structure of the transmission of the SSBs. The scheme for transmission of SSBs may be determined based on traffic conditions. In one or more example methods, determining S104 the scheme for transmission of SSBs comprises determining S104A a time spacing between the first SSB and the second SSB. The time spacing can be seen as a time spacing or a time gap separating two adjacent beam transmissions of SSB in time. FIGS. 3A-C illustrate the time spacing as Tsep. In one or more example methods, determining S104 the scheme for transmission of SSBs comprises determining S104B, based on a number of beams for SSB transmissions, a sequence of beam transmissions of SSBs.

In one or more example methods, determining S104 the scheme for transmission of SSBs comprises determining S104C the scheme based on a total number of antenna panels of the network node that are available for transmission (e.g. for broadcasting). In one or more example methods, determining S104 the scheme for transmission of SSBs comprises determining S104D the scheme based on rules indicative of subcarrier spacing and/or symbol duration (e.g. based on numerology in 3GPP). For example, this leads to determining the scheme e.g. based on a transmission time per SSB and determining the time spacing based on rules.

The method 100 optionally comprises determining, based on the first CCA, whether the channel is clear for the first beam.

The method 100 comprises upon determining, based on the first CCA, that the channel is clear for the first beam, transmitting S106, using the first beam, the first SSB indicative of the determined scheme. For example, transmitting S106, using the first beam, the first SSB indicative of the determined scheme comprises transmitting, to one or more wireless devices, using the first beam, the first SSB indicative of the determined scheme. In some examples, transmitting S106, using the first beam, the first SSB indicative of the determined scheme comprises broadcasting, using the first beam, the first SSB indicative of the determined scheme. In other words, the network node transmits, using the first beam of the network node (e.g. Tx beam) the first SSB. In some examples, the first SSB is indicative of the time spacing (such as Tsep of FIGS. 3A-C). For example, a signal sharing the time spacing to the wireless device may be included in each SSB block or signaled once at initial connection. In some examples, the time spacing may take one or more specified values, which may be detected by the wireless device.

The method 100 comprises monitoring S108, using a second beam and according to the determined scheme, the channel as part of a second CCA. In some examples, the first CCA and the second CCA may be performed in parallel.

The method 100 comprises upon determining, based on the second CCA, that the channel is clear for the second beam, transmitting S110, using the second beam, a second SSB according to the determined scheme. In some examples, transmitting S110, using the second beam, the second SSB according to the determined scheme comprises transmitting the second SSB to one or more wireless devices. In some examples, transmitting S110, using the second beam, the second SSB according to the determined scheme comprises broadcasting the second SSB.

In one or more example methods, the method comprises dynamically switching S112 between the plurality of schemes. In one or more example methods, dynamically switching S112 between the plurality of schemes comprises switching S112A between the plurality of schemes based on network traffic conditions.

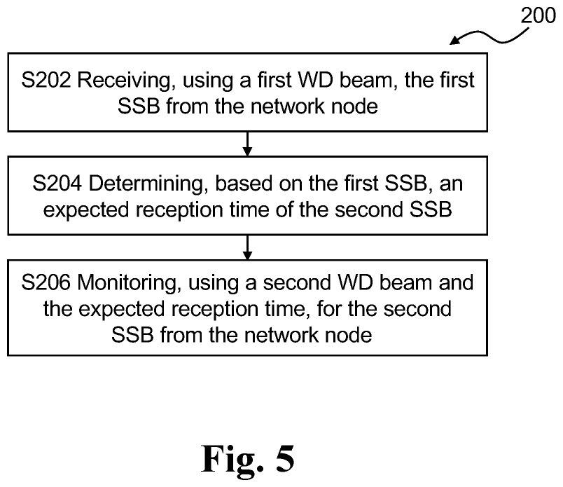

FIG. 5 is a flow-chart illustrating an example method 200, performed at wireless device, for receiving a burst of Synchronization Signal Blocks, SSBs, according to this disclosure.

The burst of SSBs comprises a first SSB and a second SSB. The wireless device, WD, is configured to communicate with a network node using a plurality of beams in a frequency band requiring clear channel assessment.

A beam may be seen as a direction, such as a spatial direction.

The plurality of beams comprises for example one or more beams of the wireless device (referred to as WD beams), and/or one or more beams of the network node (referred to as NN beams). A beam can be a receive, Rx, beam or a transmit, Tx, beam. For example, in uplink, the wireless device can communicate with the network node (such as transmit) using a Tx beam of the wireless device directed at (e.g. received by) a Rx beam of the network node. For example, in downlink, the wireless device can communicate (such as receive) with the network node via a Tx beam of the network node directed at (e.g. received by) a Rx beam of the wireless device.

In some examples, a WD Rx and a WD Tx beam may have the same spatial profile, for example may have beam correspondence.

The method 200 comprises receiving S202, using a first WD beam, the first SSB from the network node. The first WD beam used in S202 is a receive, Rx, beam of the WD.

The method 200 comprises determining S204, based on the first SSB, an expected reception time of the second SSB. For example, the first SSB is transmitted before the second SSB.

The method 200 comprises monitoring S206, using a second WD beam and the expected reception time, for the second SSB from the network node. The second WD beam used in S202 is a receive, Rx, beam of the WD.

In one or more example methods, the first SSB is indicative of a time spacing between a reception time of the first SSB and the expected reception time of the second SSB. FIGS. 3A-C illustrate the time spacing as Tsep. An SSB disclosed herein may be indicative of the time spacing. For example, all SSBs indicate the time spacing.

In one or more example methods, the time spacing is provided to the wireless device during an initial connection setup with the network node. In other words, the time spacing can be signalled in each SSB block or signalled once at initial connection setup.

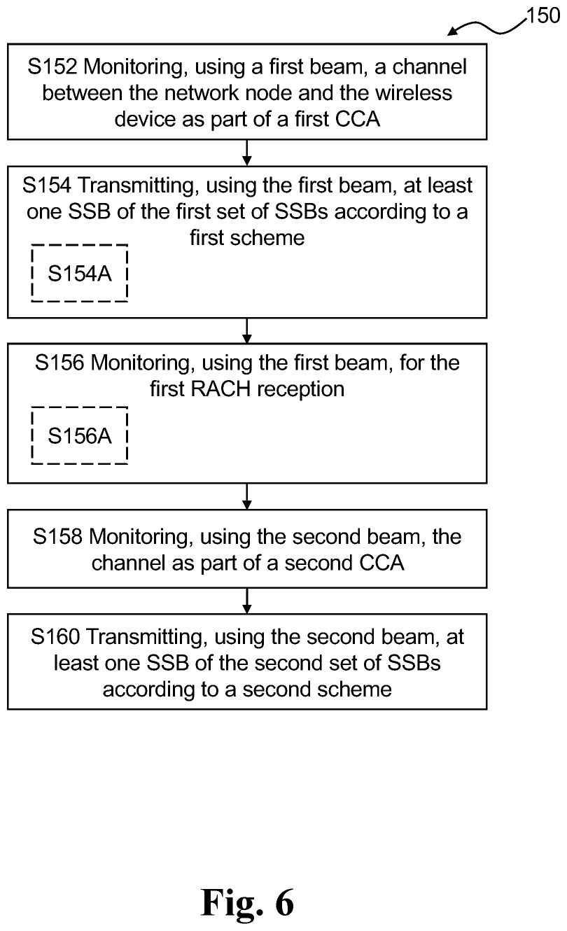

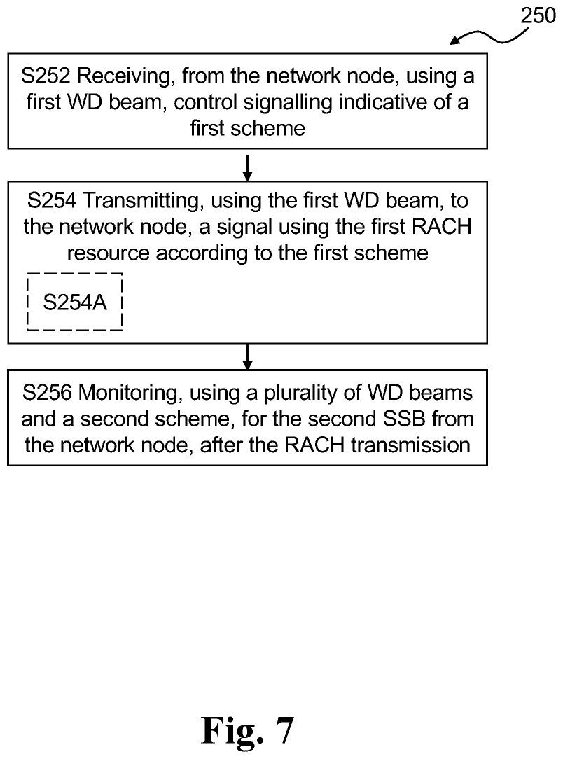

FIG. 6 is a flow-chart illustrating an example method 150, performed at a network node, for transmitting a burst of Synchronization Signal Blocks, SSBs, according to this disclosure. The burst of SSBs comprises a first set of SSBs associated with a first beam (such as a first Tx NN beam) and a second set of SSBs associated with a second beam (such as a second Tx NN beam). The network node is configured to communicate with a wireless device, using a plurality of beams comprising the first beam and the second beam, in a frequency band requiring clear channel assessment, CCA.

The method 150 comprises monitoring S152, using a first beam, a channel between the network node and the wireless device as part of a first CCA (illustrated as CCA for beam 1 in FIG. 3D).

The method 150 comprises upon determining, based on the first CCA that the channel is clear for the first beam, transmitting S154, using the first beam, at least one SSB of the first set of SSBs according to a first scheme, wherein the first scheme is configured to allow for a first Random Access Channel, RACH, reception after transmission of at least one SSB of the first set of SSBs and prior to transmitting at least one SSB of the second set of SSBs using a second beam. For example, the at least one SSB is indicative of a configuration and numbering associated with the SSBs and PRACH. For example, the SSB may comprise information indicative of the scheme used. For example, the SSB may comprise information indicative of a sequence number k ranging from K-1 to 0 as illustrated in FIG. 3D, where K denotes the total number of copies or repetitions, indexed by k. For example, a UE successfully receiving an SSB block then knows how many additional SSB blocks are left for the current beam. In some examples, transmitting S154, using the first beam, at least one SSB of the first set of SSBs according to a first scheme comprises transmitting to one or more wireless devices the at least one SSB of the first set. In some examples, transmitting S154, using the first beam, at least one SSB of the first set of SSBs according to a first scheme comprises broadcasting the at least one SSB of the first set.

The method 150 comprises monitoring S156, using the first beam, for the first RACH reception (illustrated as PRACH for beam 1 in FIG. 3D).

The method 150 comprises monitoring S158, using the second beam, the channel as part of a second CCA (illustrated as CCA for beam 2 in FIG. 3D).

The method 150 comprises, upon determining, based on the second CCA, that the channel is clear for the second beam, transmitting S160, using the second beam, at least one SSB of the second set of SSBs according to a second scheme. In some examples, transmitting S160, using the second beam, at least one SSB of the second set of SSBs according to a second scheme comprises transmitting to one or more wireless devices, using the second beam, at least one SSB of the second set of SSBs according to a second scheme. In some examples, transmitting S160, using the second beam, at least one SSB of the second set of SSBs according to a second scheme comprises broadcasting, using the second beam, at least one SSB of the second set of SSBs according to a second scheme.

In one or more example methods, the second scheme is configured to allow for at least one second RACH reception after transmission of at least one SSB of the second set and prior to transmitting at least one SSB of a third set of SSBs using a third beam.

In one or more example methods, the first set of SSBs comprises one or more SSBs and the second set of SSBs comprises one or more SSBs. For example, the SSB indicates the number of SSB of the set. The scheme is configured to allow for at least one Random Access Channel, RACH, reception after broadcasting of a present set of SSBs and prior to broadcasting a subsequent set of SSBs using a subsequent beam (as illustrated in FIG. 3D).

In one or more example methods, the first scheme is configured to allow for the first RACH reception after transmission of the first SSB of the first set of SSBs and prior to transmitting at least one SSB of the second set of SSBs using the second beam.

In one or more example methods, the first scheme is configured to allow for the first RACH reception after transmission of all SSBs of the first set and prior to transmitting at least one SSB of the second set of SSBs using the second beam.

In one or more example methods, transmitting S154, using the first beam, at least one SSB of the first set of SSBs according to the first scheme comprises transmitting S154A, using the first beam, all SSBs of the first set of SSBs prior to monitoring S156, using the first beam, for the first RACH reception.

In one or more example methods, the first scheme is configured to allow for a RACH reception after each transmission of an SSB of the first set and prior to transmitting at least one SSB of the second set of SSBs using the second beam.

In one or more example methods, monitoring S156, using the first beam, for the first RACH reception comprises monitoring S156A, using the first beam, for the first Random Access Channel, RACH, reception, after transmitting S154 of each SSBs of the first set.

In one or more example methods, resources for RACH reception are less than a threshold.

In one or more example methods, an SSB of the first set is indicative of a remaining number of SSBs in the first set for transmission; and wherein an SSB of the second set is indicative of a remaining number of SSBs in the second set for transmission. For example, the WD knows how much of the Channel Occupancy Time, COT, is left, and determines to attempt a random access (some WD's may require relatively longer time for switching from RX mode to TX mode.)

FIG. 7 is a flow-chart illustrating an example method 250, performed at the wireless device, for receiving a burst of Synchronization Signal Blocks, SSBs according to this disclosure.

The burst of SSBs comprises a first set of SSBs associated with a first beam (such as a first WD beam, such as a first beam pair of a WD beam and a NN beam), and a second set of SSBs associated with a second beam (such as a second WD beam, such as a second beam pair of a WD beam and a NN beam).

In other words, the burst of SSBs comprises a first set of SSBs to be transmitted using a first beam, and a second set of SSBs to be transmitted using a second beam (such as a second WD beam, such as a second beam pair of a WD beam and a NN beam). Optionally, the first set of SSBs comprises one or more SSBs. Optionally, the second set of SSBs comprises one or more SSBs.

The wireless device, WD, is configured to communicate with a network node using a plurality of beams in a frequency band requiring clear channel assessment.

A beam may be seen as a direction, such as a spatial direction.

The plurality of beams comprises for example one or more beams of the wireless device (referred to as WD beams), and/or one or more beams of the network node (referred to as NN beams). A beam can be a receive, Rx, beam or a transmit, Tx, beam. For example, in uplink, the wireless device can communicate with the network node (such as transmit) using a Tx beam of the wireless device directed at (e.g. received by) a Rx beam of the network node. For example, in downlink, the wireless device can communicate (such as receive) with the network node via a Tx beam of the network node directed at (e.g. received by) a Rx beam of the wireless device. In some examples, a WD Rx and a WD Tx beam may have the same spatial profile, for example may have beam correspondence.

The method 250 comprises receiving S252, from the network node, using a first WD beam, control signalling indicative of a first scheme, wherein the first scheme indicates a first Random Access Channel, RACH, resource after reception of the SSB of the first set and prior to monitoring for at least one SSB of the second set of SSBs using a second beam. In one or more example methods, the control signalling is indicative of an SSB of the first set. In one or more example methods, the SSB is indicative of the first scheme.

The method 250 comprises transmitting S254, using the first WD beam, to the network node, a signal using the first RACH resource according to the first scheme. The first WD beam is for example a Tx beam of the WD. The transmission of the signal to the network node may be received by a Rx beam of the NN. For example, transmitting S254, using the first WD beam, to the network node, the signal using the first RACH resource according to the first scheme comprises transmitting, using a first beam pair comprising the first WD Tx beam and a first NN Rx beam, to the network node, the signal using the first RACH resource according to the first scheme.

The method 250 comprises monitoring S256, using a plurality of WD beams and a second scheme, for a second SSB (such as the at least one SSB of the second set of SSBs) from the network node, after the RACH transmission S254. For example, the wireless device monitors all beams until the wireless device finds the best beam-pair before the wireless device accesses the corresponding RACH. The plurality of WD beams is for example a plurality of Rx WD beams.

In one or more example methods, the second scheme indicates a second RACH resource after reception of at least one SSB of the second set and prior to monitoring for at least one SSB of a third set of SSBs using one or more third WD beams. In other words, the second scheme has the same structure as the first scheme in some examples.

In one or more example methods, the first scheme indicates the first RACH resource after reception of the first SSB of the first set of SSBs and prior to monitoring for at least one SSB of the second set of SSBs using the plurality WD beams.

In one or more example methods, the first scheme indicates the first RACH resource after reception of all SSBs of the first set and prior to monitoring for at least one SSB of the second set of SSBs using the plurality of WD beams.

In one or more example methods, the first scheme indicates a RACH resource after each transmission of an SSB of the first set by the network node and prior to monitoring for at least one SSB of the second set of SSBs using the second WD beam.

In one or more example methods, transmitting S254, using the first WD beam, to the network node, the signal using the RACH resource according to the first scheme comprises transmitting S254A, using the first WD beam to the network node, the signal on the RACH, after reception S252 of each SSBs of the first set.

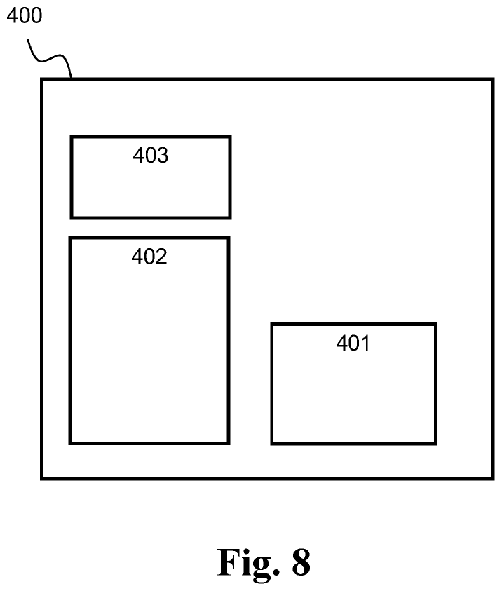

FIG. 8 shows a block diagram of an example network node 400 according to the disclosure. The network node 400 comprises circuitry, such as memory circuitry 401, processor circuitry 402, and a wireless interface 403. The network node 400 may be configured to perform any of the methods disclosed in FIG. 4. In other words, the network node 400 may be configured for transmitting a burst of Synchronization Signal Blocks according to this disclosure. The burst of SSBs comprises a first SSB and a second SSB. The network node is configured to communicate with a wireless device using a plurality of beams in a frequency band requiring clear channel assessment, CCA.

The wireless interface 403 is configured for wireless communications via a wireless communication system, such as a 3GPP system, such as a 3GPP system supporting frequency bands requiring CCA, such as the unlicensed band.

The network node 400 is configured to monitor, for example via the wireless interface 403, using a first beam, a channel between the network node and the wireless device as part of a first CCA.

The network node 400 is configured to determine, via the processor circuitry 402, a scheme for transmission of SSBs, amongst a plurality of schemes. The method comprises upon determining, based on the first CCA, that the channel is clear for the first beam, transmitting, using the first beam, the first SSB indicative of the determined scheme.

The network node 400 is configured to monitor, for example via the wireless interface 403, using a second beam and according to the determined scheme, the channel as part of a second CCA.

The network node 400 is configured to upon determining, based on the second CCA, that the channel is clear for the second beam, transmit, via the wireless interface 403, using the second beam, a second SSB according to the determined scheme.

Processor circuitry 402 is optionally configured to perform any of the operations disclosed in FIG. 4 (such as any one or more of S104A, S104B, S104C, S104D, S112, S112A). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 8). Memory circuitry 401 is considered a non-transitory computer readable medium.

Memory circuitry 401 may be configured to store beam pair information, SSB configuration, and/or schemes for SSB transmission in a part of the memory.

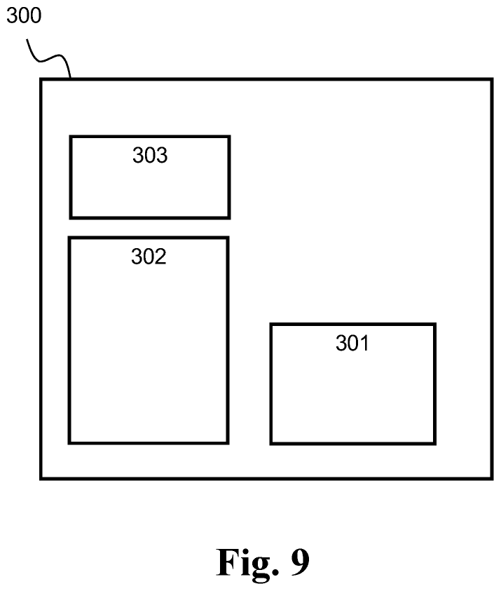

FIG. 9 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 5. In other words, the wireless device 300 may be configured for receiving a burst of Synchronization Signal Blocks, SSBs. The burst of SSBs comprises a first SSB and a second SSB. The wireless device, WD, is configured to communicate with a network node using a plurality of beams in a frequency band requiring clear channel assessment.

The wireless device 300 is configured to communicate with a network node, such as the wireless device disclosed herein, using a wireless communication system.

The wireless interface 303 is configured for wireless communications via a wireless communication system, such as a 3GPP system, such as a 3GPP system supporting unlicensed band.

The wireless device 300 is configured to receive (such as via the wireless interface 303), using a first WD beam, the first SSB from the network node.

The wireless device 300 is configured to determine (such as via the processor circuitry 302), based on the first SSB, an expected reception time of the second SSB.

The wireless device 300 is configured to monitor (such as via the wireless interface 303), using a second WD beam and the expected reception time, for the second SSB from the network node.

The wireless device 300 is optionally configured to perform any of the operations disclosed in FIG. 5. The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 9). Memory circuitry 301 is considered a non-transitory computer readable medium.

Memory circuitry 301 may be configured to store beam pair information, SSB configuration, and/or schemes for SSB transmission in a part of the memory.

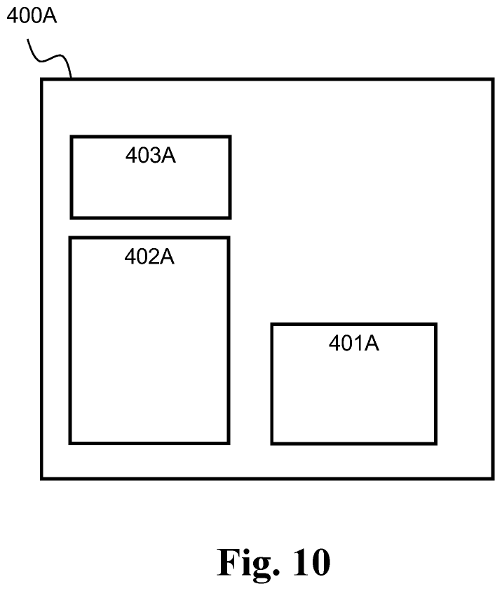

FIG. 10 shows a block diagram of an example network node 400A according to the disclosure. The network node 400A comprises circuitry, such as memory circuitry 401A, processor circuitry 402A, and a wireless interface 403A. The network node 400A may be configured to perform any of the methods disclosed in FIG. 6. In other words, the network node 400A may be configured for transmitting a burst of Synchronization Signal Blocks according to this disclosure. The burst of SSBs comprises a first set of SSBs associated with a first beam and a second set of SSBs associated with a second beam.

The network node 400A is configured to communicate with a wireless device, using a plurality of beams comprising the first beam and the second beam, in a frequency band requiring clear channel assessment, CCA.

The wireless interface 403A is configured for wireless communications via a wireless communication system, such as a 3GPP system, such as a 3GPP system supporting frequency bands requiring CCS, such as the unlicensed band.

The network node 400A is configured to monitor, for example via the wireless interface 403A, using a first beam, a channel between the network node and the wireless device as part of a first CCA.

The network node 400A is configured to, upon determining, based on the first CCA, that the channel is clear for the first beam, transmit, for example via the wireless interface 403A, using the first beam, at least one SSB of the first set of SSBs according to a first scheme. The first scheme is configured to allow for a first Random Access Channel, RACH, reception after transmission of at least one SSB of the first set of SSBs and prior to transmitting at least one SSB of the second set of SSBs using a second beam.

The network node 400A is configured to monitor, for example via the wireless interface 403A, using the first beam, for the first RACH reception.

The network node 400A is configured to monitor, for example via the wireless interface 403A, using the second beam, the channel as part of a second CCA.

The network node 400A is configured to, upon determining, based on the second CCA, that the channel is clear for the second beam, transmit, for example via the wireless interface 403A, using the second beam, at least one SSB of the second set of SSBs according to a second scheme.

Processor circuitry 402A is optionally configured to perform any of the operations disclosed in FIG. 6 (such as any one or more of S154A, S156A). The operations of the network node 400A may be embodied in the form of executable logic routines (for example, lines of code, software programs, etc.) that are stored on a non-transitory computer readable medium (for example, memory circuitry 401A) and are executed by processor circuitry 402A).

Furthermore, the operations of the network node 400A may be considered a method that the network node 400A is configured to carry out. Also, while the described functions and operations may be implemented in software, such functionality may as well be carried out via dedicated hardware or firmware, or some combination of hardware, firmware and/or software.

Memory circuitry 401A may be one or more of a buffer, a flash memory, a hard drive, a removable media, a volatile memory, a non-volatile memory, a random access memory (RAM), or other suitable device. In a typical arrangement, memory circuitry 401A may include a non-volatile memory for long term data storage and a volatile memory that functions as system memory for processor circuitry 402A. Memory circuitry 401A may exchange data with processor circuitry 402A over a data bus. Control lines and an address bus between memory circuitry 401A and processor circuitry 402A also may be present (not shown in FIG. 10). Memory circuitry 401A is considered a non-transitory computer readable medium.

Memory circuitry 401A may be configured to store beam pair information, SSB configuration, and/or schemes for SSB transmission in a part of the memory.

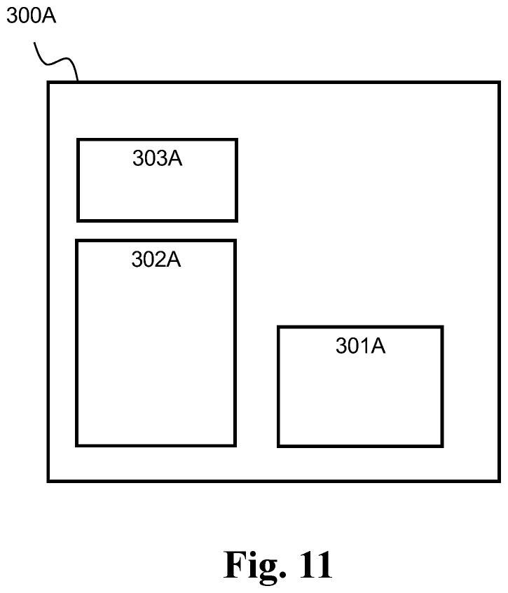

FIG. 11 shows a block diagram of an example wireless device 300A according to the disclosure. The wireless device 300A comprises memory circuitry 301A, processor circuitry 302A, and a wireless interface 303A. The wireless device 300 may be configured to perform any of the methods disclosed in FIG. 7. In other words, the wireless device 300A may be configured for receiving a burst of Synchronization Signal Blocks, SSB. The burst of SSBs comprises a first set of SSBs associated with a first beam, and a second set of SSBs associated with a second beam. The wireless device, WD, 300A is configured to communicate with a network node using a plurality of beams in a frequency band requiring clear channel assessment.

The wireless device 300A is configured to communicate with a network node, such as the wireless device disclosed herein, using a wireless communication system.

The wireless interface 303A is configured for wireless communications via a wireless communication system, such as a 3GPP system, such as a 3GPP system supporting unlicensed band.

The wireless device 300A is configured to receive (such as via the wireless interface 303A), from the network node, using a first WD beam, control signalling indicative of a first scheme, wherein the first scheme indicates a first Random Access Channel, RACH, resource after reception of the SSB of the first set and prior to monitoring for at least one SSB of the second set of SSBs using a second beam.

The wireless device 300A is configured to transmit (such as via the wireless interface 303A), using the first WD beam, to the network node, a signal using the first RACH resource according to the first scheme.

The wireless device 300A is configured to monitor (such as via the wireless interface 303A), using a plurality of WD beams and a second scheme, for the second SSB from the network node, after the RACH transmission.

The wireless device 300A is optionally configured to perform any of the operations disclosed in FIG. 7 (such as S254A). The operations of the wireless device 300A may be embodied in the form of executable logic routines (for example, lines of code, software programs, etc.) that are stored on a non-transitory computer readable medium (for example, memory circuitry 301A) and are executed by processor circuitry 302A).

Furthermore, the operations of the wireless device 300A may be considered a method that the wireless device 300A is configured to carry out. Also, while the described functions and operations may be implemented in software, such functionality may as well be carried out via dedicated hardware or firmware, or some combination of hardware, firmware and/or software.

Memory circuitry 301A may be one or more of a buffer, a flash memory, a hard drive, a removable media, a volatile memory, a non-volatile memory, a random access memory (RAM), or other suitable device. In a typical arrangement, memory circuitry 301A may include a non-volatile memory for long term data storage and a volatile memory that functions as system memory for processor circuitry 302A. Memory circuitry 301A may exchange data with processor circuitry 302A over a data bus. Control lines and an address bus between memory circuitry 301A and processor circuitry 302A also may be present (not shown in FIG. 11). Memory circuitry 301A is considered a non-transitory computer readable medium.

Memory circuitry 301A may be configured to store beam pair information, SSB configuration, and/or schemes for SSB transmission in a part of the memory.

Embodiments of methods and products (network node and wireless device) according to the disclosure are set out in the following items:
1. A method, performed at a network node, for transmitting a burst of Synchronization Signal Blocks, SSBs, comprising a first SSB and a second SSB, wherein the network node is configured to communicate with a wireless device using a plurality of beams in a frequency band requiring clear channel assessment, CCA, the method comprising:
   monitoring (S102), using a first beam, a channel between the network node and the wireless device as part of a first CCA,
   determining (S104) a scheme for transmission of SSBs, amongst a plurality of schemes,
   upon determining, based on the first CCA, that the channel is clear for the first beam, transmitting (S106), using the first beam, the first SSB indicative of the determined scheme,
   monitoring (S108), using a second beam and according to the determined scheme, the channel as part of a second CCA, and
   upon determining, based on the second CCA, that the channel is clear for the second beam, transmitting (S110), using the second beam, the second SSB according to the determined scheme.
2. The method according to item 1, wherein determining (S104) the scheme for transmission of SSBs comprises determining (S104A) a time spacing between the first SSB and the second SSB.
3. The method according to any of the previous items, wherein determining (S104) the scheme for transmission of SSBs comprises determining (S104B), based on a number of beams for SSB transmissions, a sequence of beam transmissions of SSBs.
4. The method according to any of the previous items, wherein determining (S104) the scheme for transmission of SSBs comprises determining (S104C) the scheme based on a total number of antenna panels of the network node that are available for transmission.
5. The method according to any of the previous items, wherein determining (S104) the scheme for transmission of SSBs comprises determining (S104D) the scheme based on rules indicative of subcarrier spacing and/or symbol duration.
6. The method according to any of the previous items, the method comprising dynamically switching (S112) between the plurality of schemes.
7. The method according to any of the previous items, wherein dynamically switching (S112) between the plurality of schemes comprises switching (S112A) between the plurality of schemes based on network traffic conditions.
8. A method, performed at a wireless device, for receiving a burst of Synchronization Signal Blocks, SSBs, comprising a first SSB and a second SSB, wherein the wireless device, WD, is configured to communicate with a network node using a plurality of beams in a frequency band requiring clear channel assessment, the method comprising:
   receiving (S202), using a first WD beam, the first SSB from the network node;
   determining (S204), based on the first SSB, an expected reception time of the second SSB; and
   monitoring (S206), using a second WD beam and the expected reception time, for the second SSB from the network node.
9. The method according to item 8, wherein the first SSB is indicative of a time spacing between a reception time of the first SSB and the expected reception time of the second SSB.
10. The method according to item 8, wherein the time spacing is provided to the wireless device during an initial connection setup with the network node.
11. A method, performed at a network node, for transmitting a burst of Synchronization Signal Blocks, SSBs, comprising a first set of SSBs associated with a first beam and a second set of SSBs associated with a second beam, wherein the network node is configured to communicate with a wireless device, using a plurality of beams comprising the first beam and the second beam, in a frequency band requiring clear channel assessment, CCA, the method comprising:
   monitoring (S152), using a first beam, a channel between the network node and the wireless device as part of a first CCA,
   upon determining, based on the first CCA that the channel is clear for the first beam, transmitting (S154), using the first beam, at least one SSB of the first set of SSBs according to a first scheme, wherein the first scheme is configured to allow for a first Random Access Channel, RACH, reception after transmission of at least one SSB of the first set of SSBs and prior to transmitting at least one SSB of the second set of SSBs using a second beam;
   monitoring (S156), using the first beam, for the first RACH reception;
   monitoring (S158), using the second beam, the channel as part of a second CCA, and
   upon determining, based on the second CCA, that the channel is clear for the second beam, transmitting (S160), using the second beam, at least one SSB of the second set of SSBs according to a second scheme.
12. The method according to item 11, wherein the second scheme is configured to allow for at least one second RACH reception after transmission of at least one SSB of the second set and prior to transmitting at least one SSB of a third set of SSBs using a third beam.
13. The method according to any of items 11-12, wherein the first set of SSBs comprises one or more SSBs and the second set of SSBs comprises one or more SSBs.
14. The method according to any of items 11-13, wherein the first scheme is configured to allow for the first RACH reception after transmission of the first SSB of the first set of SSBs and prior to transmitting at least one SSB of the second set of SSBs using the second beam.
15. The method according to any of items 11-14, wherein the first scheme is configured to allow for the first RACH reception after transmission of all SSBs of the first set and prior to transmitting at least one SSB of the second set of SSBs using the second beam.
16. The method according to item 15, wherein transmitting (S154), using the first beam, at least one SSB of the first set of SSBs according to the first scheme comprises transmitting (S154A), using the first beam, all SSBs of the first set of SSBs prior to monitoring (S156), using the first beam, for the first RACH reception.
17. The method according to any of items 11-16, wherein the first scheme is configured to allow for a RACH reception after each transmission of an SSB of the first set and prior to transmitting at least one SSB of the second set of SSBs using the second beam.
18. The method according to item 17, wherein monitoring (S156), using the first beam, for the first RACH reception comprises monitoring (S156A), using the first beam, for the first Random Access Channel, RACH, reception, after transmitting (S154) of each SSBs of the first set.
19. The method according to any of items 11-18, wherein resources for RACH reception are less than a threshold.
20. The method according to any of items 11-19, wherein an SSB of the first set is indicative of a remaining number of SSBs in the first set for transmission; and wherein an SSB of the second set is indicative of a remaining number of SSBs in the second set for transmission.
21. A method, performed at a wireless device, for receiving a burst of Synchronization Signal Blocks, SSBs, comprising a first set of SSBs associated with a first beam, and a second set of SSBs associated with a second beam, wherein the wireless device, WD, is configured to communicate with a network node using a plurality of beams in a frequency band requiring clear channel assessment, the method comprising:
   receiving (S252), from the network node, using a first WD beam, control signalling indicative of a first scheme, wherein the first scheme indicates a first Random Access Channel, RACH, resource after reception of the SSB of the first set and prior to monitoring for at least one SSB of the second set of SSBs using a second beam;
   transmitting (S254), using the first WD beam, to the network node, a signal using the first RACH resource according to the first scheme; and
   monitoring (S256), using a plurality of WD beams and a second scheme, for a second SSB from the network node, after the RACH transmission (S254).
22. The method according to item 21, wherein the second scheme indicates a second RACH resource after reception of at least one SSB of the second set and prior to monitoring for at least one SSB of a third set of SSBs using one or more third WD beams.
23. The method according to any of items 21-22, wherein the control signalling is indicative of an SSB of the first set, wherein the SSB is indicative of the first scheme.
24. The method according to any of items 21-23, wherein the first set of SSBs comprises one or more SSBs and the second set of SSBs comprises one or more SSBs.
25. The method according to any of items 21-24, wherein the first scheme indicates the first RACH resource after reception of the first SSB of the first set of SSBs and prior to monitoring for at least one SSB of the second set of SSBs using the plurality WD beams.
26. The method according to any of items 21-25, wherein the first scheme indicates the first RACH resource after reception of all SSBs of the first set and prior to monitoring for at least one SSB of the second set of SSBs using the plurality of WD beams.
27. The method according to any of items 21-26, wherein the first scheme indicates a RACH resource after each transmission of an SSB of the first set by the network node and prior to monitoring for at least one SSB of the second set of SSBs using the second WD beam.
28. The method according to item 27, wherein transmitting (S254), using the first WD beam, to the network node, the signal using the RACH resource according to the first scheme comprises transmitting (S254A), using the first WD beam to the network node, the signal on the RACH, after reception (S252) of each SSBs of the first set.
29. A network node comprising circuitry configured to cause the network node to perform any of the methods according to any of items 1-7.
30. A wireless device comprising circuitry configured to cause the wireless device to perform any of the methods according to any of items 8-10.
31. A network node comprising circuitry configured to cause the network node to perform any of the methods according to any of items 11-20.
32. A wireless device comprising circuitry configured to cause the wireless device to perform any of the methods according to any of items 21-28.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-11 comprises some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed at a network node, for transmitting a burst of Synchronization Signal Blocks (SSBs) comprising a first SSB and a second SSB, wherein the network node is configured to communicate with a wireless device using a plurality of beams in a frequency band requiring clear channel assessment (CCA) the method comprising:
monitoring, using a first beam, a channel between the network node and the wireless device as part of a first CCA,
determining a scheme for transmission of SSBs, amongst a plurality of schemes,
upon determining, based on the first CCA, that the channel is clear for the first beam, transmitting, using the first beam, the first SSB indicative of the determined scheme,
monitoring, using a second beam and according to the determined scheme, the channel as part of a second CCA, and
upon determining, based on the second CCA, that the channel is clear for the second beam, transmitting, using the second beam, the second SSB according to the determined scheme.

2. The method according to claim 1, wherein determining the scheme for transmission of SSBs comprises determining a time spacing between the first SSB and the second SSB.

3. The method according to claim 1, wherein determining the scheme for transmission of SSBs comprises determining, based on a number of beams for SSB transmissions, a sequence of beam transmissions of SSBs.

4. The method according to claim 1, wherein determining the scheme for transmission of SSBs comprises determining the scheme based on a total number of antenna panels of the network node that are available for transmission.

5. The method according to claim 1, wherein determining the scheme for transmission of SSBs comprises determining the scheme based on rules indicative of subcarrier spacing and/or symbol duration.

6. The method according to claim 1, the method comprising dynamically switching between the plurality of schemes.

7. The method according to claim 1, wherein dynamically switching between the plurality of schemes comprises switching between the plurality of schemes based on network traffic conditions.

8. A method, performed at a wireless device, for receiving a burst of Synchronization Signal Blocks (SBBs) comprising a first SSB and a second SSB, wherein the wireless device (WD) is configured to communicate with a network node using a plurality of beams in a frequency band requiring clear channel assessment, the method comprising:
receiving, using a first WD beam, the first SSB from the network node;
determining, based on the first SSB, an expected reception time of the second SSB; and
monitoring, using a second WD beam and the expected reception time, for the second SSB from the network node.

9. The method according to claim 8, wherein the first SSB is indicative of a time spacing between a reception time of the first SSB and the expected reception time of the second SSB.

10. The method according to claim 9, wherein the time spacing is provided to the wireless device during an initial connection setup with the network node.

11. A method, performed at a network node, for transmitting a burst of Synchronization Signal Blocks (SSB) comprising a first set of SSBs associated with a first beam and a second set of SSBs associated with a second beam, wherein the network node is configured to communicate with a wireless device, using a plurality of beams comprising the first beam and the second beam, in a frequency band requiring clear channel assessment (CCA) the method comprising:
monitoring, using a first beam, a channel between the network node and the wireless device as part of a first CCA,
upon determining, based on the first CCA, that the channel is clear for the first beam, transmitting, using the first beam, at least one SSB of the first set of SSBs according to a first scheme, wherein the first scheme is configured to allow for a first Random Access Channel (RACH) reception after transmission of at least one SSB of the first set of SSBs and prior to transmitting at least one SSB of the second set of SSBs using a second beam;
monitoring, using the first beam, for the first RACH reception;
monitoring, using the second beam, the channel as part of a second CCA, and
upon determining, based on the second CCA, that the channel is clear for the second beam, transmitting, using the second beam, at least one SSB of the second set of SSBs according to a second scheme.

12. The method according to claim 11, wherein the second scheme is configured to allow for at least one second RACH reception after transmission of at least one SSB of the second set and prior to transmitting at least one SSB of a third set of SSBs using a third beam.

13. The method according to claim 11, wherein the first set of SSBs comprises one or more SSBs and the second set of SSBs comprises one or more SSBs.

14. The method according to claim 11, wherein the first scheme is configured to allow for the first RACH reception after transmission of the first SSB of the first set of SSBs and prior to transmitting at least one SSB of the second set of SSBs using the second beam.

15. The method according to claim 11, wherein the first scheme is configured to allow for the first RACH reception after transmission of all SSBs of the first set and prior to transmitting at least one SSB of the second set of SSBs using the second beam.

16. The method according to claim 15, wherein transmitting, using the first beam, at least one SSB of the first set of SSBs according to the first scheme comprises transmitting, using the first beam, all SSBs of the first set of SSBs prior to monitoring, using the first beam, for the first RACH reception.

17. The method according to claim 11, wherein the first scheme is configured to allow for a RACH reception after each transmission of an SSB of the first set and prior to transmitting at least one SSB of the second set of SSBs using the second beam.

18. The method according to claim 11, wherein resources for RACH reception are less than a threshold.

19-20. (canceled)
